(19) United States
(12) Patent Application Publication
(10) Pub. No.: US 2010/0206018 A1
(43) Pub. Date: Aug. 19, 2010

(54) Lock Device for Photovoltaic Panels

(75) Inventor: Steve Thorne, Berkeley, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: John Danhakl, Pacific Palisades, CA (US)

(21) Appl. No.: 12/388,464

(22) Filed: Feb. 18, 2009

(51) Int. Cl. E05B 73/00; A47B 96/06

(52) U.S. Cl. 70/58; 248/309.1

(57) ABSTRACT

A photovoltaic panel locking system is disclosed. The locking system includes a unitary locking bracket made from a hardened steel material having a horizontal portion and a vertical portion extending from the horizontal portion, wherein the horizontal portion of the locking bracket is configured to encapsulate a portion of the top of the frame of a photovoltaic panel and wherein the vertical portion is configured to flank the vertical portion of the photovoltaic panel frame, and wherein the vertical portion of the bracket includes a bracket aperture. The locking system also includes a lock configured to fit through both the bracket aperture and an aligned aperture formed in the vertical portion of the frame of the photovoltaic panel securing the locking bracket against the photovoltaic panel.

### BACKGROUND OF THE INVENTION

The present invention relates generally to the locking of photovoltaic panels, and, more particularly, to locking devices for use with photovoltaic panels.

The production of energy utilizing solar panels has increased rapidly in the last decade. Solar panels are favored as flexible sources of stand alone power generation.

Solar panels are commonly placed on commercial and residential rooftops, garages, carports, on land contiguous to swimming pools, on telephone poles, and at just about any remote location where there is direct sunlight and the need for electrical energy. Because solar panels produce energy without the need for an engaged operator or attendant, most of the locations where panels are installed are unsupervised and offer very little security. Accordingly, such installations leave the panels vulnerable to theft.

What makes solar panels attractive to thieves is their relatively high value. A solar panel of typical dimensions of approximately 3 ft wide by 5 ft high presently costs about $500-$600, and when grouped into an array of 20 or 30 panels their cumulative cost is equivalent to the cost of an automobile.

Additionally, solar panels are easily disassembled, very transportable and can be easily installed elsewhere without a documentable means to trace their origin. For example, while an automobile's documentable means to trace its origin is its license plate and vehicle registration number; solar panels provide no such means, except for an easily removed certification sticker.

Therefore, because solar panels are expensive, easily disassembled, untraceable, transportable, and located in areas of low security, they have become a particularly attractive object for thieves. Accordingly, there remains an unmet need for a locking mechanism for photovoltaic panels.

### BRIEF SUMMARY OF THE INVENTION

The present invention is related to devices that can be used to secure solar panels in a lockable manner so as to make the theft of such panels less likely. In one aspect, the present invention provides a unique locking device that can secure a solar panel and serve as a significant obstacle to their theft. The present invention can also provide a unique locking device that can secure an array of solar panels and serve as a significant obstacle to their theft.

In one aspect, the present invention provides a photovoltaic panel locking system. The locking system includes a unitary locking bracket made from a hardened steel material having a horizontal portion and a vertical portion extending from the horizontal portion, wherein the horizontal portion of the locking bracket is configured to encapsulate a portion of the top of the frame of a photovoltaic panel and wherein the vertical portion is configured to flank the vertical portion of the photovoltaic panel frame, and wherein the vertical portion of the bracket includes a bracket aperture. The locking system also includes a lock configured to fit through both the bracket aperture and an aligned aperture formed in the vertical portion of the frame of the photovoltaic panel securing the locking bracket against the photovoltaic panel.

For a further understanding of the nature and advantages of the invention, reference should be made to the following description taken in conjunction with the accompanying figures. It is to be expressly understood, however, that each of the figures is provided for the purpose of illustration and description only and is not intended as a definition of the limits of the embodiments of the present invention.

### BRIEF DESCRIPTION OF THE DRAWINGS

The embodiments of the present invention, illustrating their features, will now be discussed in detail. These embodiments depict the novel and nonobvious locking device for photovoltaic panels shown in the accompanying drawings, which are included for illustrative purposes only. These drawings include the following figures, where:

FIG. 1 is a perspective view of a locking bracket device in accordance with one embodiment of the present invention.

FIG. 2 is a partial sectional view of the locking bracket of FIG. 1 shown configured between two PV-panels.

FIG. 3 is a perspective view of the locking bracket of FIG. 1 shown configured between two PV-panels.

FIGS. 4A, 4B, and 4C are perspective views of the end and middle configurations of the locking bracket of FIG. 1.

FIG. 5 is a perspective view of a locking bracket in accordance with an alternative embodiment of this invention.

FIG. 6 is a partial sectional view of the locking bracket of FIG. 5 shown configured between two PV-panels.

FIG. 7 is a perspective view of the locking bracket of FIG. 5 shown configured between two PV-panels.

FIG. 8 is a top view diagram illustrating a secured linear array of PV-panels in accordance with one embodiment of the present invention.

FIG. 9 is a top view diagram illustrating a secured two-dimensional array of PV-panels in accordance with one embodiment of the present invention.

FIG. 10A is a perspective view of a locking bracket device in accordance with a second alternative embodiment of the present invention for use with a lock.

FIG. 10B is a perspective view of a locking bracket device of FIG. 10A shown for use with a cable or a chain.

FIG. 11 is a partial sectional view of the locking bracket of FIG. 10B shown configured between two PV-panels.

FIG. 12 is a perspective view of the locking bracket of FIG. 10A shown configured with a lockable bar.

FIGS. 13A-B illustrate a bracket locking device in accordance with a third alternative embodiment of the present invention.

FIG. 13C shows a side view corresponding to FIGS. 13A-B.

FIG. 14 is an exploded assembly view drawing corresponding to the locking bracket of FIGS. 13A-B.

FIG. 15 shows a bracket locking device in accordance with a fourth alternative embodiment of the present invention.

### DETAILED DESCRIPTION OF THE INVENTION

The embodiments of the present invention are related to devices that can be used to secure solar panels in a lockable manner so as to make the theft of such panels less likely.

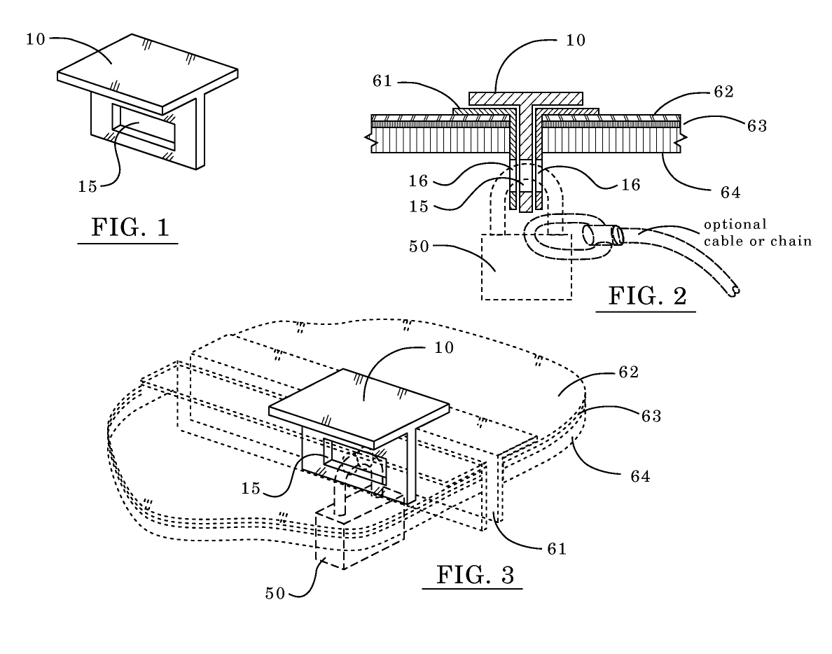

FIG. 1 shows a perspective view of a locking bracket device in accordance with one embodiment of the present invention. The bracket 10 includes a horizontal upper portion that is connected with a vertical slot member 15. The bracket is shown to have a T-shaped cross-section. The T-shaped cross section lends itself well to being placed between photovoltaic panels to secure them in place. The bracket 10 can be a unitary piece formed by a casting operation or it can be formed from two portions and joined together by a welding, brazing or other such process to form the unitary piece. The bracket 10 is made of hardened steel material similar to that used with bicycle and motorcycle locks. In addition, all of the steel elements that might come into contact with the aluminum frame of the panels are powder coated or otherwise protected to prevent electrolysis or galvanic corrosion.

FIG. 2 shows a partial sectional view of the locking bracket 10 of FIG. 1 shown configured between two PV-panels. As shown in FIG. 2, each photovoltaic panel may include a backing 64, the photovoltaic panel 63 and a panel glass 62 which is disposed over the panel 63. A panel frame 61, typically made of aluminum, is shown disposed over the panel glass 62. The bracket 10 is shown disposed between two adjacent panels. The bracket 10 can be secured to penal frame 61 by placing a padlock or other similar lock 50 through the bracket slot 15 and the aligned frame slots 16. The panel frame 61 and bracket 10 can then be further secured to a nearby pole or structural element of the rooftop that supports the panel utilizing a cable or chain looped through the hasp of padlock 50. Alternatively, in lieu of padlock 50, a cable or a chain may be directed through both slot 15 and frame slots 16 to secure the locking bracket with the photovoltaic panels to a fixed structure. The locking bracket is dimensioned and configured to lock the photovoltaic panels in place in such a manner that attempts to cut through the bracket 10, for example by a saw blade or cutting wheel 80 would fracture panel glass 62 and also result in damage to the photovoltaic panel 63, rendering the panels essentially worthless to a thief and thus deterring their unauthorized removal. FIG. 3 shows a perspective view of the locking bracket of FIG. 1 shown configured between two PV-panels. The upper horizontal portion is dimensioned and configured to encapsulate the panel frame. The vertical section is dimensioned to be thin enough to fit between adjacent panel frames. The vertical section is dimensioned to be not too long so that it does not extend too far beyond the panels so as to prevent its unauthorized removal by a saw or blow torch without damaging the panels themselves. It should be noted that for the device of FIGS. 1, 2 and 3 the vertical leg of the bracket projects down to about the bottom of the panel frames. The user either has to cut a hole or slot in the frames or the frames would be manufactured with the slot/hole to allow the padlock hasp to pass through both the bracket and the frames. If the slot 15 was lower than the bottom of the frame, a thief could simply slide the locked bracket down the crack that separates the two frames and remove it. Accordingly, in one embodiment, the locking bracket 10 works with an aligned slot/hole. Note that the hardened steel vertical leg of the ‘T’ bracket keeps a thief from taking a hack-saw or the like and cutting out the bracket from below.

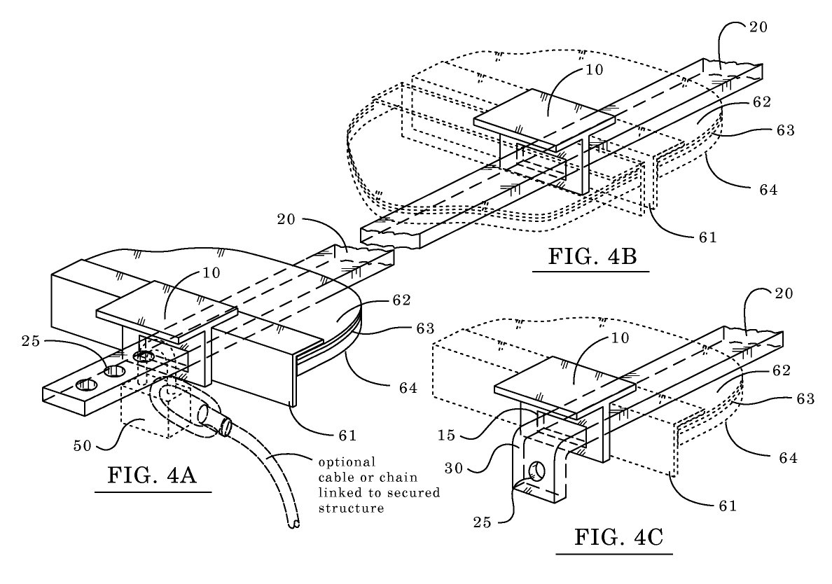

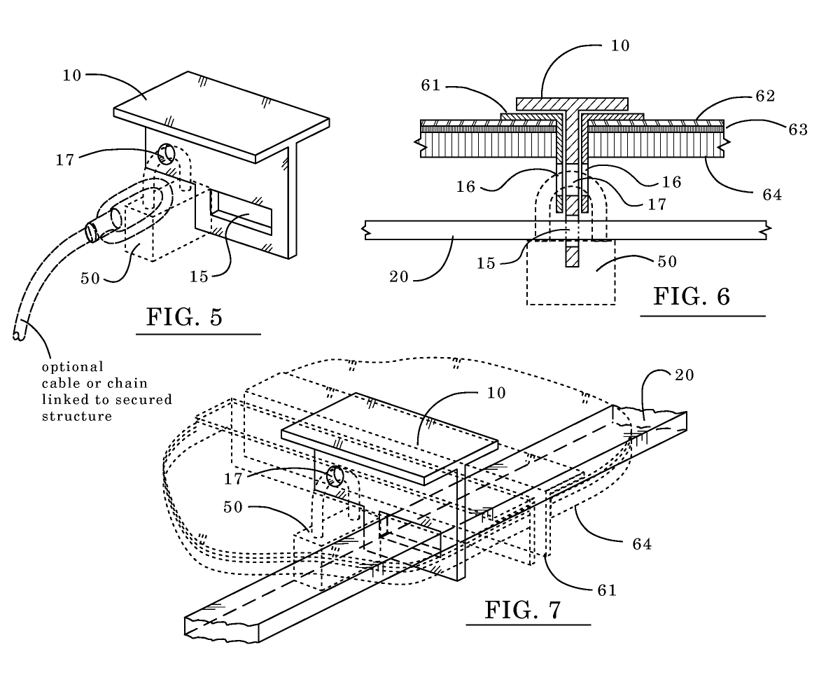

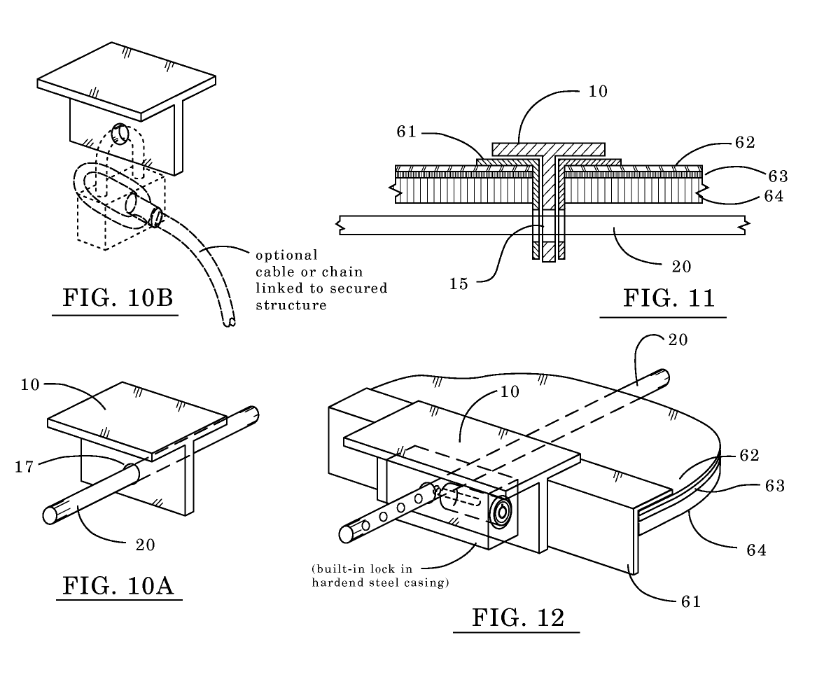

For purposes of clarification, turning to FIGS. 5, 6 and 7 it is noted that the bar is placed lower than the frame, as opposed to the locking bracket of FIGS. 1-3. But in order to keep the bracket of FIGS. 5-7 from being slid off, the bracket itself locks to each frame, as best seen in FIG. 7. The advantages to this bracket design are that it allows a bigger flat bar to be used for security, and only requires that the user drill round holes to align with bracket hole 17. If one compares the embodiments shown in FIGS. 5-7 with the embodiments disclosed in FIGS. 4A, 4B, and 4C, one can see that the FIG. 4 device requires either the user or the manufacturer to cut slots in the frame to accommodate the bar. Because users don't always have tools to cut slots, it may be more practical for the bar to be round in section like that shown in FIG. 10A, FIG. 10B, and FIG. 11.

FIGS. 4A, 4B, and 4C are perspective views of the end and middle configurations of the locking bracket of FIG. 1 when used to secure a linear array of panels or a series of contiguous panels. As is shown in these figures a bar 20 may be used instead of the lock 50 to secure the bracket 10 with the panels. The bar 20 itself may then be secured by using a lock 50 or a cable or chain via the bar lock hole 25. Shown in FIG. 4C is an alternative configuration for the bar 20. As is shown, optionally, in lieu of a padlock on both ends, the bar 20 may include a bend 30 that prevents the bar from being slid free of bracket 10. Vertical leg of bend 30 can include bar lock hole 25 to permit the attachment of a lock or a cable or chain to the bar 20. While bar 20 is shown to be rectangular in cross-section, a square profiled bar or a round bar or rod may also be used.

As described above, a cable attachment may be used, but, of course, this may also be a chain long enough to wrap around an adjacent secured object, for example a pole, or secured element of the structure supporting the panels. It should be realized that wherever there is a padlock shown, a cable/chain attachment linked to the hasp may also be used.

FIG. 5 shows a perspective view of a locking bracket in accordance with an alternative embodiment of this invention. This alternative bracket 10 is shown to have an upper horizontal member from which a vertical section projects downward. The vertical section includes both a slot 15 and a bracket lock hole 17. The bracket lock hole 17 is configured to receive a lock 50 or other such device and the slot 15 can be used to receive a lock or the bar 20 as described above. As described above, optionally or in addition to the lock 50 or bar 20, or a cable or chain may be used with the slot 15 or bracket lock hole 17 to secure the bracket 10 with the photovoltaic panels or a secure structure. FIG. 6 shows a partial sectional view of the locking bracket of FIG. 5 shown configured between two PV-panels. FIG. 7 shows a perspective view of the locking bracket of FIG. 5 shown configured between two PV-panels. As is shown in FIGS. 5-7, the bracket 10 can be a unitary piece formed by a casting operation or it can be formed from the two portions and joined together by a welding, brazing or other such process to form the unitary piece. The bracket 10 is also hardened to resist cutting. As is shown the vertical portion of the locking bracket 10 has a stepped profile, where the slot 15 projects lower than the vertical portion that surrounds the bracket lock hole 17. This is advantageous in that the slot 15 can accommodate a bar 20 that can pass through the slot 15 without interfering with the photovoltaic panels yet still allows for a lock with standard hasp dimensions to loop through hole 17 and frame holes 16. However, it should be noted that the vertical section can be configured without the stepped profiles if a lock with extended hasp length is used; the vertical portion of the bracket 10 is similar in profile to that shown in FIGS. 1-4C.

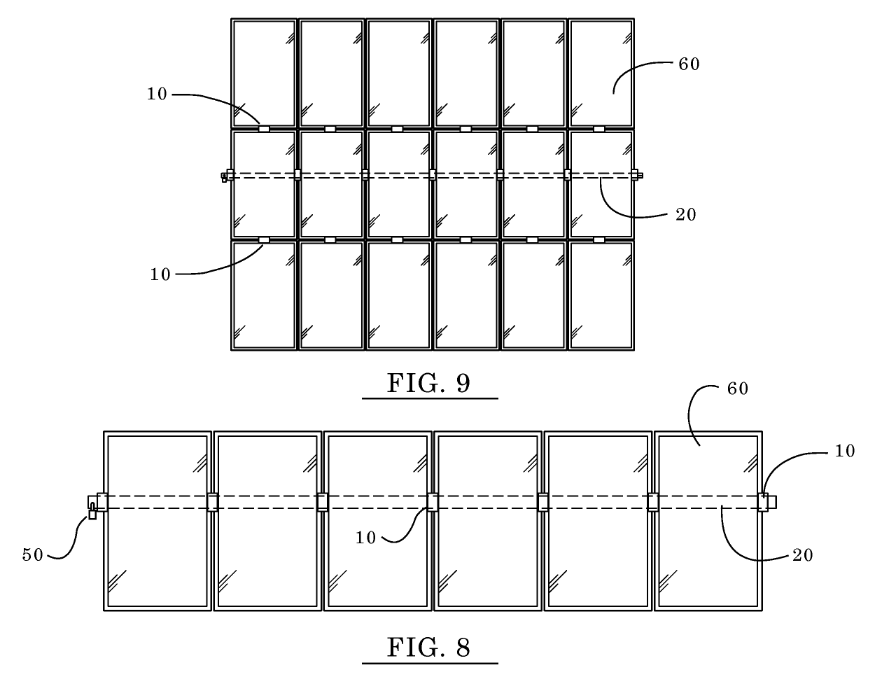

FIG. 8 shows a top view diagram illustrating a secured row or column of PV-panels 60 in accordance with one embodiment of the present invention. As shown in this figure, a plurality of locking brackets 10 are placed between and at the ends of the array of panels. A bar 20 having a bend 30 may be used to slide through slots 15 in the brackets 10. One end of the bar 20 can be secured by a lock 50 to secure the panels 60. It should be noted that in the case where bracket 10 as embodied by FIG. 1 is used (which doesn't lock each bracket to the frames) it is preferred that the locked length of bar 20 not exceed the array length by any substantial margin otherwise the panels might be shifted left and right to allow a gap between the bracket and panel frame sufficiently large to allow the frames to be cut out around each bar penetration. Since it is preferred to not manufacture bars of different lengths to accommodate all the different panel sizes, therefore, bars would likely have multiple offset bar holes 25 at one or both ends (e.g., about 2 inches on center).

FIG. 9 shows a top view diagram illustrating a secured two-dimensional array of PV-panels in accordance with one embodiment of the present invention. As is shown in this figure, a plurality of locking brackets 10 are placed between and at the ends of the array of panels. The brackets disposed along the vertical direction individually lock contiguous panel in the vertical direction. In addition, another set of brackets 10 are shown secured via bar 20 secured through slots 15. It should be noted that only one bar is needed if the other panel lines above and below the line of panels secured via bar 20 are locked to those panels.

The arrangement for locking the array is similar to that for a single panel on a pole, but the attachment may also include a connection to a portion of the building that it mounts to. In some cases though, there is no secure building, or the array just sits on the ground. For such installations, if each panel was only secured using single panel locks, and were further attached together with the cable, then a thief could simply fold one panel onto another and carry off the entire group of so-stacked panels. So the device shown above includes the hardened steel bar of sufficient extension that the size of the array cannot be substantially reduced, for example by stacking them. If panels are secured to this bar, they cannot be folded together, and their larger configuration cannot be carried off easily, for it won't fit into the back of a car or truck. Thus, the bar element provides a unique advantage for the locking of photovoltaic panels.

FIG. 10A shows a perspective view of a bracket locking device 10 in accordance with a second alternative embodiment of the present invention for use with a lock. As is shown in this figure, the vertical member of the bracket 10 includes a bracket lock hole 17, instead of the rectangular slot 15 shown on the previous embodiments. FIG. 10B is a perspective view of the bracket locking device of FIG. 10A shown for use with a bar. The hole 17 is configured to received a lock, a rod or bar 20 or a cable or chain to secure the bracket 10.

FIG. 11 is a partial sectional view of the locking bracket of FIG. 10B shown configured between two PV-panels. As shown in FIG. 11, each photovoltaic panel may include a backing 64, the photovoltaic panel 63 and a panel glass 62 which is disposed over the panel 63. A panel frame 61 is shown disposed over the panel glass 62. The bracket 10 is shown disposed between two adjacent panels. The bracket 10 can be secured by placing a padlock, other similar lock 50 or a bar or a rod through the bracket slot 15 and frame slots 16.

FIG. 12 is a perspective view of the locking bracket of FIG. 10A shown configured with a lockable bar 20. This figure shows that the bar or rod 20 may include indentations, depressions or holes along its length that are configured to received a lock pin. Preferably, the lock pin is a part of a lock and hardened casing integrated with brackets at the ends of a linear array. Thus, to lock the array, one would place typical brackets 10 between each of the middle panels and the lockable bracket shown in FIG. 12 at the ends (or one end if the bar has a bend in it). The user then would drill frame slots (holes) to align with the brackets, and would slide the hardened steel rod through the length of the array to lock it up.

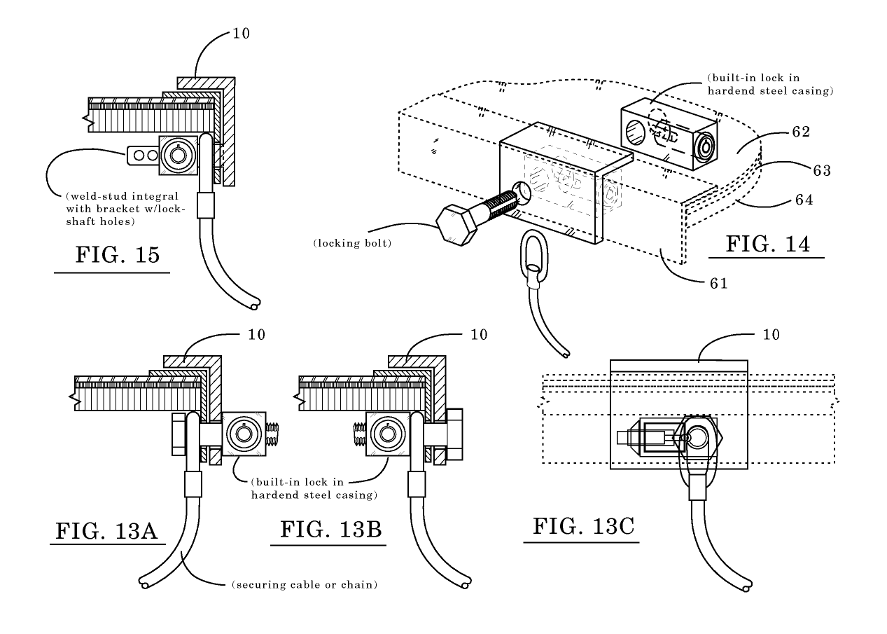

Shown in FIGS. 13A-14 is a bracket locking device 10 in accordance with a third alternative embodiment of the present invention. As shown in these figures, the bracket 10 has an L-shaped cross-section. This type of locking bracket is more suitable for securing an individual panel, or for securing the photovoltaic panels at the end of a row or column of panels. This bracket 10 includes a hole configured to receive a locking bolt which is locked by a lock pin of a lock. This arrangement also requires a slight modification to the panel frame 61 so that it too has a hole or slot to receive the locking bolt. In addition to or optionally, a cable, or a chain may also be secured to the bracket 10 via the locking bolt. As described above, the locking bracket is made of hardened steel and is powder coated.

FIG. 15 illustrates a bracket locking device in accordance with a fourth alternative embodiment of the present invention. This alternative locking bracket has an L-shaped cross-section and also includes a weld-stud formed integral with the L-shaped bracket. The weld-stud is locked by a lock pin of a lock. This type of locking bracket is more suitable for securing an individual panel, or for securing the photovoltaic panels at the end of a row or column of panels, and its operation is simplified since the locking-bolt of FIGS. 13A-14 is now formed integral with the bracket. This arrangement also requires a slight modification to the panel frame 61 so that it too has a hole or slot to receive the locking bolt. In addition to or optionally, a cable, or a chain may also be secured to the bracket 10 via the locking bolt

The photovoltaic locking bracket described herein is advantageous for several reasons. For some applications, such as a single panel attached to a telephone pole, or the like, the locking device in accordance with the embodiments of the present invention provides a device that can simply attach to the frame and lock to an unmovable object. However, because photovoltaic panels are fabricated using soft aluminum frames, one can't just toss a lock onto it, for a thief will be able to cut off the aluminum portion it attaches to. The present locking bracket, which is preferably made of hardened steel material, can encapsulate a portion of the frame. To cut out the bracket, a thief would have to cut out a portion of the panel which would break the glass face and render part of the panel useless—making it unlikely to be resold.

As will be understood by those skilled in the art, the present invention may be embodied in other specific forms without departing from the essential characteristics thereof. For example, the vertically extending portion of the locking bracket may use any combination of slots or holes or differently-shaped apertures to receive a lock, a bar, or a rod or it may be made of any hardened steel material suitable for locking applications. Many other embodiments are possible without deviating from the spirit and scope of the invention. These other embodiments are intended to be included within the scope of the present invention, which is set forth in the following claims.

What is claimed is:

1. A photovoltaic lock system for locking a photovoltaic panel having a frame, comprising:
a unitary locking bracket made from a hardened steel material having a horizontal portion and a vertical portion extending from the horizontal portion,
wherein said horizontal portion of said locking bracket is configured to encapsulate a portion of the top of the frame of a photovoltaic panel and wherein said vertical portion is configured to flank the vertical portion of the photovoltaic panel frame, said vertical portion of the bracket having a bracket aperture; and
a lock configured to fit through both said bracket aperture and an aligned aperture formed in the vertical portion of the frame of the photovoltaic panel securing said locking bracket against the photovoltaic panel.

2. The photovoltaic lock system of claim 1, wherein said vertical portion is configured to project downward not more than the vertical portion of the photovoltaic frame.

3. The photovoltaic lock system of claim 1, further comprising a securing cable or chain connected to the hasp of said lock.

4. The photovoltaic lock system of claim 1, further comprising
a bar configured to fit within said bracket aperture to secure said locking bracket against the photovoltaic panel.

5. The photovoltaic lock system of claim 4, wherein said bar is configured to slide through an aligned aperture formed in the frame of the photovoltaic panel.

6. The photovoltaic lock system of claim 4, wherein said bracket aperture is one of two bracket apertures, where a first aperture is complementarily-shaped to receive said lock and a second aperture is complementarily-shaped to receive said bar.

7. The photovoltaic lock system of claim 6, wherein said bracket apertures are formed in said vertical portion of said bracket, wherein said second aperture projects downward more than the vertical portion of the photovoltaic frame, and wherein said bar is configured to slide through said second aperture and not slide through an aligned aperture formed in the frame of the photovoltaic panel.

8. The photovoltaic lock system of claim 1, wherein said bracket aperture is complementarily-shaped to receive said lock.

9. The photovoltaic lock system of claim 1, wherein said unitary locking bracket has a T-shaped cross-section.

10. The photovoltaic lock system of claim 1, wherein said unitary locking bracket has an L-shaped cross-section.

11. The photovoltaic lock system of claim 1, wherein said unitary locking bracket is coated so as to prevent galvanic corrosion between said unitary locking bracket and the portion of a frame of the photovoltaic panel which it encapsulates.

12. A photovoltaic lock system for locking a photovoltaic panel having a frame, comprising:
a unitary locking bracket made from a hardened steel material having a horizontal portion and a vertical portion extending from the horizontal portion,
wherein said horizontal portion of said locking bracket is configured to encapsulate a portion of the top of the frame of a photovoltaic panel and wherein said vertical portion is configured to flank the vertical portion of the photovoltaic panel frame, said vertical portion of the bracket having a bracket aperture;
a locking bolt configured to fit through both said bracket aperture and an aligned aperture formed in the vertical portion of the frame of the photovoltaic panel; and
a lock configured to receive said locking bolt fit through both said bracket aperture and an aligned aperture formed in the vertical portion of the frame of the photovoltaic panel securing said locking bracket against the photovoltaic panel.

13. The photovoltaic lock system of claim of claim 12, further comprising a securing cable or chain connectable with said locking bolt.

14. The photovoltaic lock system of claim of claim 12, wherein said unitary locking bracket has a L-shaped cross-section.

15. The photovoltaic lock system of claim of claim 12, wherein said unitary locking bracket is coated so as to prevent galvanic corrosion between said unitary locking bracket and the portion of a frame of the photovoltaic panel which it encapsulates.

16. The photovoltaic lock system of claim of claim 12, wherein said vertical portion is configured to project downward not more than the vertical portion of the photovoltaic frame.
